(19) United States
(12) Patent Application Publication
(10) Pub. No.: US 2021/0405293 A1
(43) Pub. Date: Dec. 30, 2021

(54) SYSTEM AND METHOD FOR TREATING THE END OF AN OPTICAL FIBER BUNDLE TO REDUCE LIGHT REFLECTION

(71) Applicant: Precision Optics Corporation, Inc., Gardner, MA (US)

(72) Inventors: Bruce M. Radl, Stow, MA (US); David E. Chambers, Warren, MA (US)

(21) Appl. No.: 17/354,159

(22) Filed: Jun. 22, 2021

Related U.S. Application Data
(60) Provisional application No. 63/043,189, filed on Jun. 24, 2020.

(51) Int. Cl. G02B 6/25; G02B 6/04; C03C 25/105; C03C 25/36

(52) U.S. Cl. CPC G02B 6/25; C03C 25/36; C03C 25/105; G02B 6/04

(57) ABSTRACT

A system and method for treating the end of an optical fiber bundle to reduce light scattering/reflection is provided. After the end of the optical fiber bundle is formed, it has a raw end. A material is applied to the raw end to form a treated end that provides a substantially smoother surface then the raw cut end, which reduces the amount of light rays reflected from the end.

### CROSS-REFERENCE TO RELATED APPLICATIONS

The present application claims priority to commonly assigned co-pending U.S. Provisional Patent Application Ser. No. 63/043,189, which was filed on Jun. 24, 2020, by Bruce M. Radl, et al. for SYSTEM AND METHOD FOR TREATING THE END OF AN OPTICAL FIBER BUNDLE TO REDUCE LIGHT REFLECTION, which is hereby incorporated by reference.

### BACKGROUND

### Technical Field

The present invention relates to optical fibers and more particularly to finishing the end of a bundle of optical fibers.

### Background Information

Optical fibers are used to transmit light, or other electromagnetic radiation, along its length. To cause efficient coupling of the radiation into and out of an optical fiber or a bundle of optical fibers, both end faces are typically finished with a glossy surface that is achieved by optical polishing. The smooth surface is also beneficial as it eliminates sharp edges that are present on the tip of a roughly finished optical fiber. These sharp edges may negatively impact the usefulness of the fiber due to the mechanical sharpness of the tips. The sharp edges also make the tips more prone to being damaged during use. Illustratively, a progression of finer and finer grit optical abrasives are used with a lapping tool to reduce the surface roughness of the end face until it achieves a suitably smooth and shiny surface that is substantially flat and free of pits and/or scratches. This polishing is illustratively performed in a multistep process that requires a substantial amount of time. The result is a surface on the end face that, similar to a polished lens, allows a substantial amount of light to be captured with only Fresnel losses. This achieves the most optically efficient and mechanically functional and robust end to an optical fiber or optical fiber bundle; however, the method is quite costly and requires a substantial amount of time to perform the plurality of rounds of polishing.

The conventional polishing technique has worked well for reusable endoscopes and/or other devices where the additional costs required for processing the optical fiber end can be supported by the selling price of the reusable endoscopes. However, for single-use endoscopes (or other single use devices), where cost is critically important, these solutions are not practical. More generally, the conventional, multistep polishing technique may prevent the manufacture and/or assembly of low-cost devices where it is desirous to use optical fibers. Thus, there is a need for a low-cost and efficient method for finishing the ends of optical fibers for use with low cost and/or single use devices.

### SUMMARY

The noted disadvantages of the prior art are overcome by providing a system and method for treating the ends of an optical fiber bundle to reduce light scattering and to provide an optically smooth end. The various embodiments described herein may be accomplished using substantially fewer resources than conventional optical fiber polishing, thereby reducing the overall cost of components that utilize optical fibers prepared in accordance with the various illustrative embodiments herein.

Illustratively, the end of an optical fiber bundle, which may comprise one or more optical fibers, is cut or otherwise terminated to have a raw cut end. A material, such as an epoxy, is spread over the raw end of the optical fiber bundle and allowed to cure. Optionally, the material may be shaped by, e.g., cleaving the material to a substantially flat surface or forming the material into some other illustrative shape. When utilized to collect light, the treated end of the optical fiber bundle captures or emits substantially more light than a raw end. This reduces the number of light rays that are reflected and thereby improves the efficiency of light transmission through the optical fiber bundle. When utilized to emit light, the treated end of an optical fiber bundle emits more light into an angular distribution that is substantially determined by the optical properties of the optical fiber than a raw end.

### BRIEF DESCRIPTION OF THE DRAWINGS

The above and further advantages of the present invention are described herein in connection with the accompanying figures in which like reference numerals indicate identical or functionally similar elements, of which:

FIG. 1 is a perspective view of an exemplary optical fiber accordance with an illustrative embodiment of the present invention;

FIG. 2 is a cross-sectional view of an optical fiber illustrating light ray propagation in accordance with an illustrative embodiment of the present invention;

FIG. 3 is a perspective view of an exemplary optical fiber bundle in accordance with an illustrative embodiment of the present invention;

FIG. 4A is a side view of an optical fiber bundle end illustrating light ray reflections off of a polished surface in accordance with an illustrative embodiment of the present invention;

FIG. 4B is a side view of an optical fiber bundle end illustrating light ray reflections off of a raw edge surface in accordance with an illustrative embodiment of the present invention;

FIG. 4C is a side view of an optical fiber bundle end illustrating light ray reflections off of an end of an optical fiber bundle treated in accordance with an illustrative embodiment of the present invention;

FIG. 4D is a side view of an optical fiber bundle end illustrating light rays emitted from an optical fiber with a polished surface in accordance with an illustrative embodiment of the present invention;

FIG. 4E is a side view of an optical fiber bundle end illustrating light rays emitted from an optical fiber with a raw edge surface in accordance with an illustrative embodiment of the present invention;

FIG. 4F is a side view of an optical fiber bundle end illustrating light rays emitted from an end of an optical fiber bundle treated in accordance with an illustrative embodiment of the present invention;

FIG. 5A is a side view of an exemplary optical fiber bundle with material attached in accordance with an illustrative embodiment of the present invention;

FIG. 5B is a side view of an exemplary optical fiber bundle showing material that has been made flat in accordance with an illustrative embodiment of the present invention;

FIG. 5C is a side view of an exemplary optical fiber bundle illustrating a shaped material end in accordance with an illustrative embodiment of the present invention; and

FIG. 6 is a flowchart detailing the steps of a procedure for treating the end of an optical fiber bundle in accordance with an illustrative embodiment of the present invention.

### DETAILED DESCRIPTION OF AN ILLUSTRATIVE EMBODIMENT

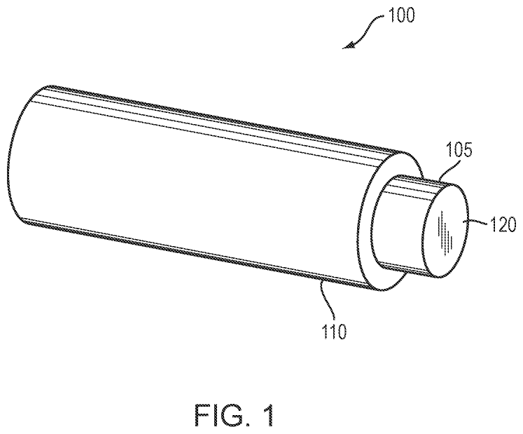

FIG. 1 is in exemplary perspective view of an optical fiber 100 that may be utilized in accordance with illustrative embodiments of the present invention. The optical fiber 100 illustratively comprises of an optical core 105 and a cladding 110 layer. In alternative embodiments, a plurality of optical fibers 100 may be arranged in a bundle. Further, in alternative embodiments of the present invention the cladding 110 layer may be arranged in differing configurations. As such, the arrangement of the exemplary optical fiber 100 shown in FIG. 1 should be taken as exemplary only.

Illustratively, the core 105 is made of glass or plastic and is clear so that light (or other electromagnetic radiation) will propagate through it. The core has an exemplary end surface 120 that may be used to capture or emit light, or other electromagnetic radiation, in accordance with illustrative embodiments of the present invention. As noted above, typically the end 120 is polished using a multi-step polishing technique that takes a substantial amount of time and greatly increases the overall cost of finishing an optical fiber. In accordance with illustrative embodiments of the present invention, a technique is described to treat the end 120 of the optical fiber core 105 to improve its optical collection or emission properties over those of a raw (i.e., not polished or treated) end. More generally, the treatment method described herein significantly reduces the amount of light reflected from an exemplary treated end 120 as compared to an exemplary raw end 120 of an optical fiber core 105.

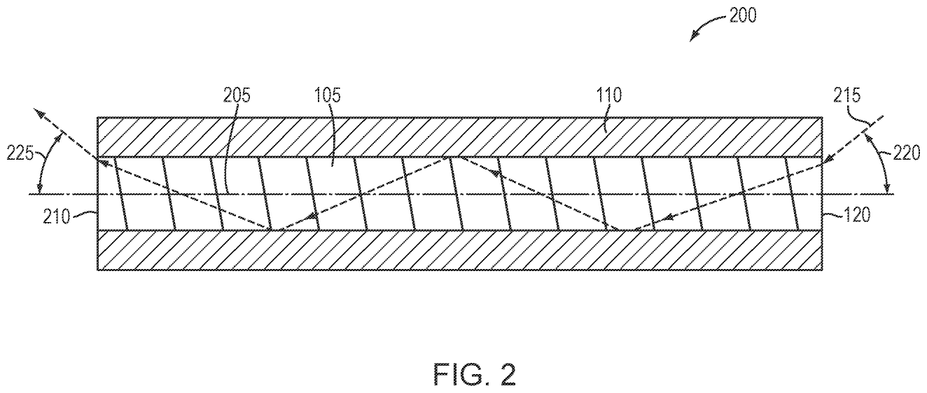

FIG. 2 is a cross-sectional view 200 of an exemplary optical fiber 100 in accordance with illustrative embodiment of the present invention. Exemplary light ray 215 enters the inner core 105 from a first end 120. As will be appreciated by those skilled in the art, there is a maximum light input angle 215 that can enter the core 105 and propagate via total internal reflection (TIR) through the core 105 based on the index of refraction properties of the core and cladding material. The cladding 110 protects the inner core material and prevents light from escaping. The light ray 215 propagates through the inner core material as indicated by the arrows and then exits the exemplary optical fiber at a second end 210. The maximum light output angle 225 that exits the core 105 is also characteristic of the index of refraction difference between the core and cladding materials.

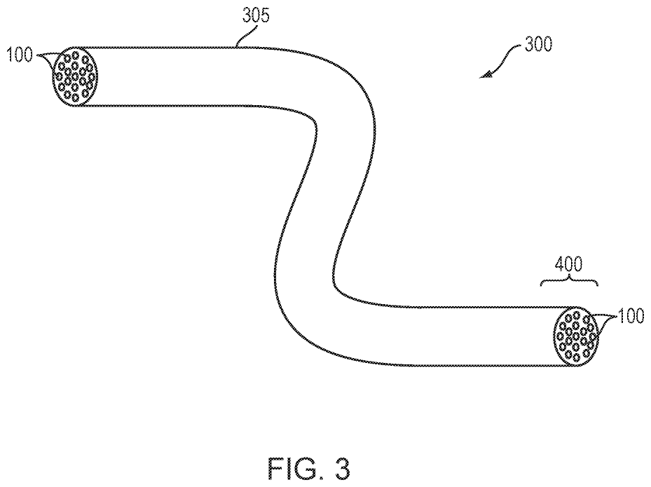

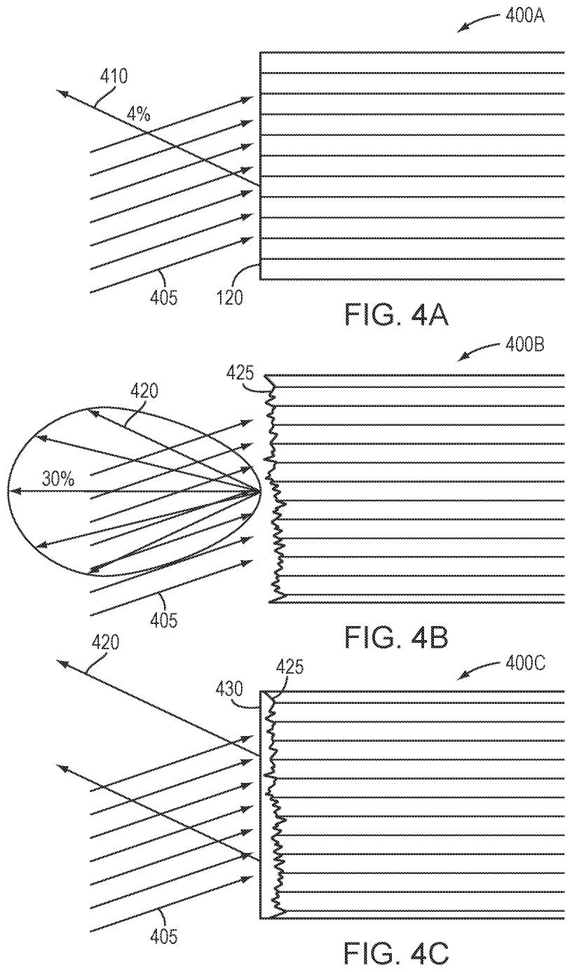

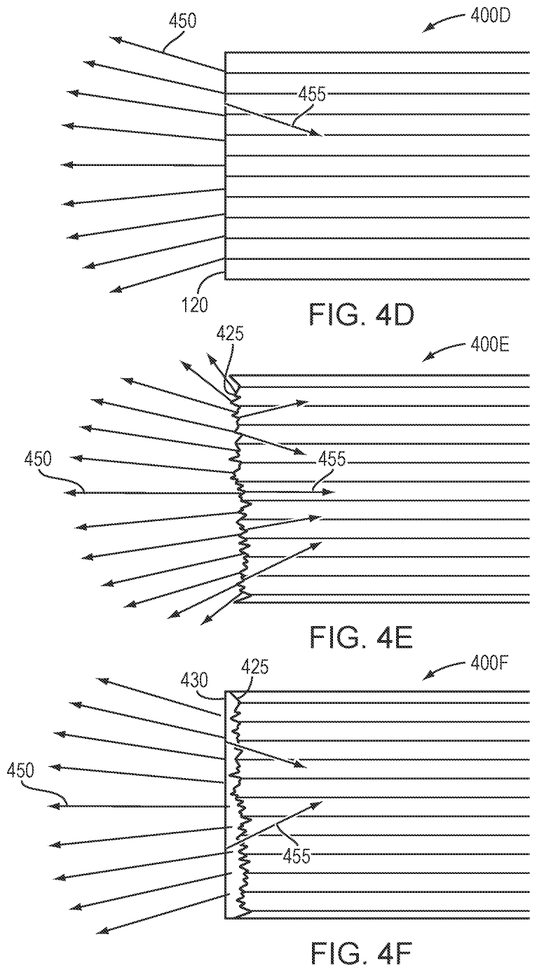

As will be appreciated by those skilled in the art, not all light rays 215 that impact with end 120 are captured by the optical core 105. Some percentage of light rays are reflected off the end 120 and are not captured. Conventional polishing techniques for end 120 works to enable a very low percentage of light rays being reflected. This is described below in relation to FIGS. 4A-C.

FIG. 3 is an exemplary perspective view 300 of an exemplary optical fiber bundle 305 in accordance with an illustrative embodiment of the present invention. Illustratively, optical fiber bundle 305 comprises of a plurality of optical fibers 100. However, it should be noted that in alternative embodiments of the present invention, an optical fiber bundle may have only a single optical fiber. Therefore, the description of an optical fiber bundle having a plurality of optical fibers should be taken as exemplary only. As will be appreciated but by those skilled in the art, the optical fibers 100 may be arranged in various patterns within bundle 305. Further, the cross-section of optical fiber bundle 305 may be of various shapes. Therefore, the illustration of optical fiber bundle 305 in FIG. 3 as being substantially circular in cross section and having the optical fibers 100 be arranged in a certain pattern should be taken as exemplary only.

One exemplary end region 400 of the optical fiber bundle 305 is shown in FIGS. 4A-C, each of which represents an exemplary differing end surface treatment. Each FIG. 4A-C) further illustrates the amount of light that is reflected back and not transmitted through an optical fiber bundle having an end treated as shown in that figure.

FIG. 4A is a side view of an exemplary optical fiber having an end surface 120 that is polished in accordance with conventional multi-step polishing techniques. As will be appreciated from view 400A, due to the substantially flat and polished surface 120, the vast majority of the entering light rays that impact with surface 120 are retained by the various optical fibers. Only a small percentage of light waves are reflected 410. It has been observed that the number of light rays reflected 410 is approximately 4% for a high quality polished optical fiber bundle end 120 such as optical fibers made of typical glass materials that are used for visible light optical fibers in medical endoscopes.

FIG. 4B is a side view of 400B an exemplary optical fiber bundle having a raw end 425. The raw end surface 425 may be achieved by, e.g., cutting the optical fiber bundle, etc. As can be seen from view 400B, a substantial percentage of entering light rays 405 that impact with the raw end surface 425 are reflected as reflected light rays 420. As the raw end 425 has an irregular, potentially jagged surface, from the uneven ends of the individual optical fibers, many light rays 405 thus impact the raw end 425 are reflected 420 instead of being captured by the optical fibers. Illustratively, approximately 30% of light rays 405 that impact with the raw end surface 425 are reflected and not transmitted through optical fiber bundle.

FIG. 4C is a side view 400C of an exemplary optical fiber bundle that has its raw end surface 425 coated with a material to create a treated end 430 in accordance with an illustrative embodiment of the present invention. As can be seen from exemplary view 400C, a significant amount of the light rays 405 that impact with the treated end surface 430 are retained by the optical fibers of the optical fiber bundle. Some light rays 420 are reflected from the treated surface 430. Illustratively, the number of light rays that are reflected 420 are more than that those reflected from the polished surface 120 (FIG. 4A), but substantially less than those reflected from a raw end surface 425 (FIG. 4B). It has been observed that the percentage of light rays reflected 420 off of an exemplary treated surface 430 is in the range of approximately 5-10%.

FIG. 4D is a side view 400D of an optical fiber bundle end illustrating light rays emitted from an optical fiber with a polished surface in accordance with an illustrative embodiment of the present invention. View 400D illustrates a substantial number of light rays 450 being emitted from polished end 120. Only a small number of light rays 455 are reflected back into the optical fiber bundle.

FIG. 4E is a side view 400E of an optical fiber bundle end illustrating light rays emitted from an optical fiber with a raw edge surface in accordance with an illustrative embodiment of the present invention. Light rays 450 are emitted, but may be emitted at a variety of angles from raw end 425. A significant number of light rays 455 are reflected back into the bundle.

FIG. 4F is a side view 400F of an optical fiber bundle end illustrating light rays emitted from an end of an optical fiber bundle treated in accordance with an illustrative embodiment of the present invention. Similar to FIG. 4D, a large number of light rays are emitted. The number of light rays 455 that are reflected back is larger than in FIG. 4D, but significantly less than in the case of a raw end in FIG. 4E.

By use of the present invention, the amount of light captured or emitted is increased as compared to the use of raw end, while avoiding the time and expense of multiple rounds of polishing as required by conventional techniques.

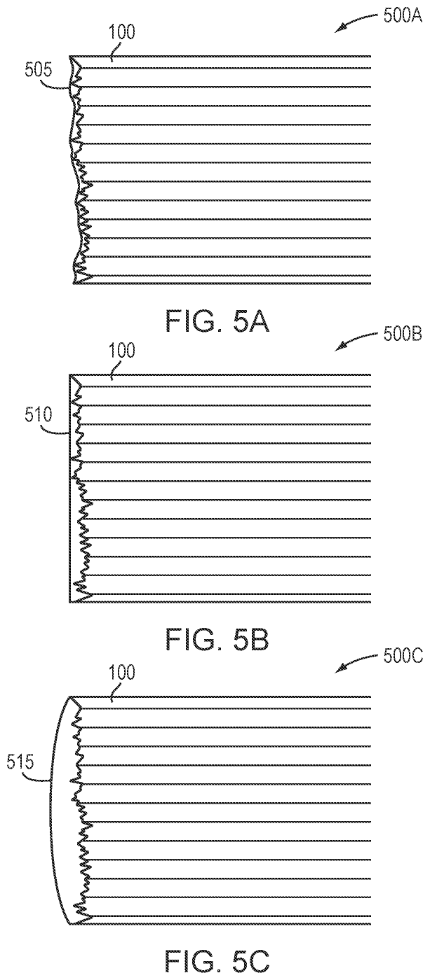

In accordance with illustrative embodiments of the present invention, the raw end may have material applied in various manners to create a treated end. Exemplary FIGS. 5A-C illustrate three such techniques. It should be noted that in alternative embodiments of the present invention, other techniques may be utilized. Therefore, the description of exemplary techniques described below should be taken as exemplary only.

FIG. 5A is a side view of an exemplary optical fiber bundle 500A illustrating a small amount of material having been applied in accordance with an illustrative embodiment of the present invention. In the embodiment displayed in FIG. 5, the material 505 has been applied to the raw end of the optical fiber bundle, but has not been shaped in any manner. As can be seen, the end is smoother than the raw end, but is not substantially flat.

Exemplary optical fiber bundle 500A illustrates a minimalistic approach in accordance with an illustrative embodiment of the present invention. Bundle 500A may be achieved by spreading a small amount of material onto a raw end of an optical fiber bundle, but then taking no further action. Bundle 500A will capture or emit more light rays than a raw end, but not as many as exemplary bundles 500B-C, described further below.

FIG. 5B is a side view of an exemplary optical fiber bundle 500B in accordance with an illustrative embodiment of the present invention. Exemplary optical fiber bundle 500B had material applied on the raw end surface 425. The material, once hardened, has been deposited flat, cut, or otherwise processed, to form a substantially flat surface 510. As will be appreciated by those skilled in the art, this cutting may be performed by use of appropriate knife-edged cutting device. In alternative embodiments, the cutting may be performed by laser processing. Generally, any technique for cutting a material and leaving a substantially smooth surface may be utilized in accordance with alternative embodiments of the present invention. Therefore, the description of a mechanical cutting process using a knife-edged cutting device should be taken as exemplary only.

The substantially flat surface 510 that is created by cutting, or otherwise processing, the material, enables a large percentage of light rays that impact the surface 510 to be captured or light rays to be emitted from surface 510. Exemplary edge 510 is substantially flat, although not as flat and polished as a conventionally finished end 120. The material is illustratively thicker than in exemplary bundle 500A. The overall thickness of material may vary depending on the point of cutting.

FIG. 5C is a side view of an exemplary optical fiber bundle 500C where material has been placed over raw end surfaces and has been shaped 515 in accordance with an illustrative embodiment of the present invention. Exemplary material has been shaped 515 into a convex shape. It should be noted that in alternative embodiments, the end shape 515 may be concave, or other shapes. Therefore, the description and illustration of a convex shape should be taken as exemplary only. It should be noted that such shapes may be created during the application of the material. For example, the naturally occurring meniscus from application of the material in a liquid form. Such shapes may also be formed after application by shaping the material after it is applied to the raw end surface. In some cases, the processing of the raw end may be performed similarly to that conventionally performed to grind and polish a glass surface. However, as the material is softer than glass, such polishing may be performed in a faster and easier manner than polishing the glass end directly. In further alternative embodiments, the end of the optical fiber may have material applied by e.g., three-dimensional printing, molding material, replication, etc. As such, the description of application of epoxy should be taken as exemplary only.

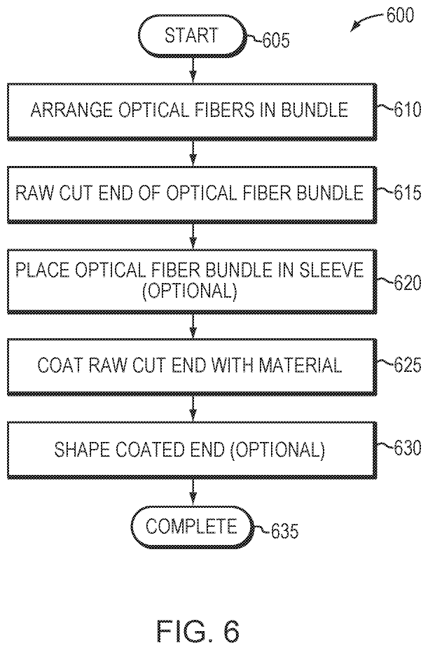

FIG. 6 is a flowchart detailing the steps of an exemplary procedure 600 for treating the end of an optical fiber bundle in accordance with an illustrative embodiment of the present invention. The procedure 600 begins in step 605 and continues to step 610 where the optical fibers are arranged in the bundle. Optical fibers may be organized into a bundle using a variety of known techniques. Illustratively, the optical fibers may be arranged during manufacturing, so the optical fibers share a common sheath. Alternatively, a plurality of optical fibers may be spatially arranged and then a potting material is applied to hold the optical fibers within the bundle. Alternatively, a plurality of optical fibers may be spatially arranged and then held in place manually, i.e., by hand. In alternative embodiments, an optical fiber bundle may comprise of a single optical fiber. In such alternative embodiments, a single optical fiber does not need further processing to be placed in a bundle. More generally, the arrangement of one or more optical fibers into an optical fiber bundle may include, e.g., arranging the optical fibers so that they are in a particular shaped pattern when viewing a cross-section through the diameter of the optical fiber bundle. Similarly, the cross-section of the optical fiber bundle may have a plurality of shapes. Therefore, the description contained herein of a substantially circular optical fiber bundle should be taken as exemplary only.

Then, in step 615, one end of the optical fiber bundle is cut to generate a raw end surface. Illustratively, the raw end surface of the optical fiber bundle may be generated using any of a number of techniques, e.g., by cutting using a mechanical device, etc. The term cut should be construed broadly to include any method of terminating the end of the optical fiber bundle. Other than mechanical cutting, this may include, e.g., laser cutting, chemical cutting, thermal cutting, etc.

In optional step 620, the optical fiber bundle is then placed in a sleeve or otherwise arranged so that the ends are aligned so that material may be placed on the raw cut ends. More generally, the various optical fibers are arranged so that application of material to the raw cut ends is made easier. In step 625, the raw end surface is coated with a material. Illustratively, the material is an epoxy, such as an optical adhesive used to bond or pot optical elements as is known to one skilled in the art. One example of such an optical adhesive is Norland Optical Adhesive 61. However, it should be noted that in accordance with illustrative embodiments of the present invention, the material may be a substance other than epoxy. Illustratively, any material that is transparent or translucent to the desired light range may be utilized. Therefore, the description of the use of an epoxy as the material to be utilized should be taken as exemplary only.

The material of the coated end may be shaped in optional step 630. The shaping may be performed using any of a number of techniques. In one illustrative embodiment, the shaping may comprise cutting the end of the material to achieve a substantially flat surface, such as that shown above in relation to FIG. 5B. In alternative embodiments, the material may be physically shaped to be concave or convex such as that shown above in relation to FIG. 5C. In further alternative embodiments, the material may be arranged in other shapes (not shown). Therefore, the description and illustration of the material being shaped into a convex, concave, or substantially flat shapes should be treated as exemplary only. In alternative embodiments, the coated end is not shaped, therefore the description of optional step 630 should be taken as exemplary only.

The procedure 600 then completes in step 635. Once procedure 600 has completed, the end of the optical fiber bundle has been coated and optionally shaped with the desired material. In operation, the use of an optical fiber bundle having an end that has been treated in accordance with embodiments of the present invention greatly reduces the amount of light rays that are reflected, thereby substantially increasing the amount of light (or other electromagnetic radiation), that is captured or emitted by the optical fiber bundle. An optical fiber bundle treated in accordance with illustrative embodiments of the present invention may not capture or emit as much light as a conventionally polished end but will capture or emit substantially more light than a raw cut end.

It should be noted that the various descriptions and embodiments described herein are exemplary only. While this description has been written in terms of certain materials, it should be noted that, in alternative embodiments, differing materials may be utilized. As such, the description of any specific materials should be taken as exemplary only. Further, while the description of the material being used to treat the ends of the optical fiber bundle is described as an epoxy, in alternative embodiments it is expressly contemplated that other materials may be utilized. Therefore, the description of the material being used as an epoxy should be taken as exemplary only.

What is claimed is:

1. A method comprising the steps of:
forming an optical fiber bundle;
forming a raw end on the optical fiber bundle; and
coating the raw end of the optical fiber bundle with a material to form a treated end of the optical fiber bundle, wherein the treated end reflects a smaller percentage of light than reflected by the raw end.

2. The method of claim 1 wherein the optical fiber bundle contains one optical fiber.

3. The method of claim 1 wherein the optical fiber bundle comprises a plurality of optical fibers.

4. The method of claim 1 wherein forming the raw end of the optical fiber bundle comprises cutting the optical fiber bundle.

5. The method of claim 1 wherein the material comprises an epoxy.

6. The method of claim 1 further comprising forming the material into a shape on the treated end of the optical fiber bundle.

7. The method of claim 6 wherein the shape is a convex shape.

8. The method of claim 6 wherein the shape is a concave shape.

9. The method of claim 1 wherein the material is deposited with a substantially flat surface on the treated end.

10. The method of claim 1 further comprising cutting through the material to form a substantially flat surface of the treated end.

11. The method of claim 1 wherein coating the raw end of the optical fiber bundle with the material further comprises applying a plurality of coats of the material to the raw cut end of the optical fiber bundle to form the treated end of the optical fiber bundle.

12. An apparatus comprising:
an optical fiber having a first raw cut end; and
a first material coating the first raw cut end, wherein the first material reduces reflection.

13. The apparatus of claim 12 wherein the first material comprises an epoxy.

14. The apparatus of claim 12 wherein the first raw cut end is made by cutting a first end of the optical fiber.

15. The apparatus of claim 12 wherein the optical fiber is part of an optical fiber bundle.

16. The apparatus of claim 12 wherein the optical fiber has a second raw cut end, wherein the second raw cut end is coated with a second material.

17. The apparatus of claim 16 wherein the first material differs from the second material.

18. An apparatus comprising:
an optical fiber bundle comprising of a plurality of optical fibers, each of the optical fibers having a first raw cut end; and
a first material coating the first raw cut end of each of the plurality of optical fibers.

19. The apparatus of claim 18 wherein each of the plurality of optical fibers having a second raw cut end, wherein a second material coating the second raw cut end of each of the plurality of optical fibers.
